(19) United States
(12) Patent Application Publication
(10) Pub. No.: US 2005/0138371 A1
(43) Pub. Date: Jun. 23, 2005

(54) Method and system for distribution of notifications in file security systems

(75) Inventors: Senthilvasan Supramaniam, Sunnyvale, CA (US); Yevgeniy Gutnik, Sunnyvale, CA (US)

Correspondence Address: John S. Ferrell at Carr & Ferrell LLP, 2200 Geng Road, Palo Alto, CA, 94303, US

(73) Assignee: PSS Systems, Inc.

(21) Appl. No.: 10/742,710

(22) Filed: Dec. 19, 2003

(51) Int. Cl. H04L 9/00

(52) U.S. Cl. 713/165

(57) ABSTRACT

Improved approaches for providing notifications in a distributed file security system are disclosed. The file security system includes a file security server that manages file security for a plurality of clients. When security criteria (e.g., security policies or rules) change at the file security system, typically the clients need to be notified so that they operate in accordance with the correct security criteria. The security criteria impacts whether a particular client (or its user) are able to access certain files being protected by the file security system. A client can be notified in different ways depending on network characteristics. In one embodiment, an appropriate way to perform notifications between the file security server and clients can be automatically determined, thus advantageously minimizing user impact and allowing the system to transparently adapt to different networks.

### CROSS-REFERENCE TO RELATED APPLICATIONS

This application is related to U.S. patent application Ser. No. 10/186,203, filed Jun. 26, 2002, and entitled “METHOD AND SYSTEM FOR IMPLEMENTING CHANGES TO SECURITY POLICIES IN A DISTRIBUTED SECURITY SYSTEM,” which is hereby incorporated by reference for all purposes. This application is also related to U.S. patent application Ser. No. 10/074,194, filed Feb. 12, 2002, and entitled “SYSTEM AND METHOD FOR PROVIDING MULTI-LOCATION ACCESS MANAGEMENT TO SECURED ITEMS,” which is hereby incorporated by reference for all purposes.

### BACKGROUND OF THE INVENTION

1. Field of the Invention

The present invention relates to security systems for data and, more particularly, to security systems that protect data in an inter/intra enterprise environment.

2. Description of Related Art

The Internet is the fastest growing telecommunications medium in history. This growth and the easy access it affords have significantly enhanced the opportunity to use advanced information technology for both the public and private sectors. It provides unprecedented opportunities for interaction and data sharing among businesses and individuals. However, the advantages provided by the Internet come with a significantly greater element of risk to the confidentiality and integrity of information. The Internet is an open, public and international network of interconnected computers and electronic devices. Without proper security means, an unauthorized person or machine may intercept information traveling across the Internet and even gain access to proprietary information stored in computers that interconnect to the Internet.

There are many efforts in progress aimed at protecting proprietary information traveling across the Internet and controlling access to computers carrying the proprietary information. Cryptography allows people to carry over the confidence found in the physical world to the electronic world, thus allowing people to do business electronically without worries of deceit and deception. Every day millions of people interact electronically, whether it is through e-mail, e-commerce (business conducted over the Internet), ATM machines, or cellular phones. The perpetual increase of information transmitted electronically has led to an increased reliance on cryptography.

One of the ongoing efforts in protecting the proprietary information traveling across the Internet is to use one or more cryptographic techniques to secure a private communication session between two communicating computers on the Internet. The cryptographic techniques provide a way to transmit information across an unsecure communication channel without disclosing the contents of the information to anyone eavesdropping on the communication channel. Using an encryption process in a cryptographic technique, one party can protect the contents of the data in transit from access by an unauthorized third party, yet the intended party can read the encrypted data after using a corresponding decryption process.

A firewall is another security measure that protects the resources of a private network from users of other networks. However, it has been reported that many unauthorized accesses to proprietary information occur from the inside, as opposed to from the outside. An example of someone gaining unauthorized access from the inside is when restricted or proprietary information is accessed by someone within an organization who is not supposed to do so. Due to the open nature of networks, contractual information, customer data, executive communications, product specifications, and a host of other confidential and proprietary intellectual property remain available and vulnerable to improper access and usage by unauthorized users within or outside a supposedly protected perimeter.

Many businesses and organizations have been looking for effective ways to protect their proprietary information. Typically, businesses and organizations have deployed firewalls, Virtual Private Networks (VPNs), and Intrusion Detection Systems (IDS) to provide protection. Unfortunately, these various security means have been proven insufficient to reliably protect proprietary information residing on private networks. For example, depending on passwords to access sensitive documents from within often causes security breaches when the password of a few characters long is leaked or detected. Consequently, various cryptographic means are deployed to provide restricted access to electronic data in security systems.

As previously noted, security systems can operate to restrict access to data (e.g., files). Typically, the data is provided in an electronic file and stored in an encrypted fashion so that only authorized users can gain access to such files. The security system operates in accordance with security criteria. Typically, a system administrator would set the security criteria. However, the security criteria often needs to be updated to handle various events, such as adding a new user or dropping an old user from the security system. In security systems that operate in a networked environment, it is difficult to notify the various clients or user machines of the changes to the security criteria. In some networks, only one-way data transmissions are permitted. As a result, the many clients or user machines must periodically poll the security system for the changes to the security criteria, if any. This approach results in an inefficient usage of network resources if, in fact, two-way data transmission are permitted. Hence, users or administrators are forced to configure clients or user machines to obtain the security system changes in one of these ways. However, such configurations may require changes when the clients or user machines thereafter utilize different networks in communicating with the security system.

Therefore, there is a need to provide more effective ways for security systems to notify clients or user machines of changes to security criteria.

### SUMMARY OF THE INVENTION

The invention pertains to improved techniques for providing notifications in a distributed file security system. More particularly, the file security system includes a file security server that manages file security for a plurality of clients. When security criteria (e.g., security policies or rules) change at the file security system, typically the clients need to be notified so that they operate in accordance with the correct security criteria. The security criteria impacts whether a particular client (or its user) are able to access certain files being protected by the file security system. According to the invention, a client can be notified in different ways depending on network characteristics. In one embodiment, the invention facilitates automatic determination of an appropriate way to perform notifications between the file security server and clients. The invention advantageously minimizes user impact and allows the system to transparently adapt to different networks.

The invention can be implemented in numerous ways, including as a method, system, device and computer readable medium. Several embodiments of the invention are discussed below.

As a computer-implemented method for providing a security change notification to clients of a file security system, one embodiment of the invention includes at least the acts of: interacting with a first client of the file security system to determine a determined delivery type for security criteria change notifications; determining whether a security criteria change to the file security system has been made; preparing a security criteria change notification based on the security policy change; and delivering the security criteria change notification to the first client using the determined delivery type.

As a computer-implemented method for providing a security change notification to a client of a file security system where the client communicates with the file security system via a network, another embodiment of the invention includes at least the acts of: placing the client into a first state that causes the client to poll the file security system to inquire whether there are any security criteria change notifications for the client and to obtain security criteria changes for the client if there are any; automatically assisting the file security system with an evaluation of network topology of the network; subsequently receiving a request to switch the client to a second state in which the client is not required to poll the file security system in order to obtain any security criteria change notifications for the client, the request being sent to the client from the file security system dependent on the network topology; and switching the client from the first state to the second state in response to the request.

As a security system for securing files from unauthorized access within a distributed computer network, one embodiment of the invention includes at least: a server module operating on a server, and a plurality of client modules operating on respective user computers. The server module stores security policy information that governs a type and extent of access to secured files that are permitted by users via the respective user computers. The client modules receive some or all of the portion of the security policy information from the server module. In addition, the server module and the client module interact, without user input, to determine a manner by which said client modules are to be notified of subsequent changes to the security policy information.

As a computer readable medium including at least computer program code for providing a security change notification to clients of a file security system, one embodiment of the invention includes at least: computer program code for interacting with a first client of the file security system to determine a determined delivery type for security criteria change notifications; computer program code for determining whether a security criteria change to the file security system has been made; computer program code for preparing a security criteria change notification based on the security policy change; and computer program code for delivering the security criteria change notification to the first client using the determined delivery type.

As a computer readable medium including at least computer program code for providing a security change notification to a client of a file security system, where the client communicates with the file security system via a network, one embodiment of the invention includes at least: computer program code for placing the client into a first state that causes the client to poll the file security system to inquire whether there are any security criteria change notifications for the client and to obtain security criteria changes for the client if there are any; computer program code for automatically assisting the file security system with an evaluation of network topology of the network; computer program code for subsequently receiving a request to switch the client to a second state in which the client is not required to poll the file security system in order to obtain any security criteria change notifications for the client, the request being sent to the client from the file security system dependent on the network topology; and computer program code for switching the client from the first state to the second state in response to the request.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings wherein:

FIG. 1A is a diagram of a security system according to one embodiment of the invention.

FIG. 1B is a flow diagram of a security policy change notification process according to one embodiment of the invention.

FIG. 2 is a flow diagram of a login process according to one embodiment of the invention.

FIG. 3 is a flow diagram of a delivery type determination process according to one embodiment of the invention.

FIG. 4 is a flow diagram of server-side delivery type determination process according to one embodiment of the invention.

FIGS. 5A and 5B are flow diagrams of a client-side delivery type determination process according to one embodiment of the invention.

FIG. 6 is a diagram of a server state machine according to one embodiment of the invention.

FIG. 7 is a diagram of a client state machine according to one embodiment of the invention.

FIG. 8A shows a basic system configuration in which the invention may be practiced in accordance with an embodiment thereof.

FIG. 8B shows another system configuration in which the invention may be practiced in accordance with an embodiment thereof.

FIG. 8C shows still another system configuration in which the invention may be practiced in accordance with an embodiment thereof.

### DETAILED DESCRIPTION OF THE INVENTION

The invention pertains to improved techniques for providing notifications in a distributed file security system. More particularly, the file security system includes a file security server that manages file security for a plurality of clients. When security criteria (e.g., security policies or rules) change at the file security system, typically the clients need to be notified so that they operate in accordance with the correct security criteria. The security criteria impacts whether a particular client (or its user) are able to access certain files being protected by the file security system. According to the invention, a client can be notified in different ways depending on network characteristics. In one embodiment, the invention facilitates automatic determination of an appropriate way to perform notifications between the file security server and clients. The invention advantageously minimizes user impact and allows the system to transparently adapt to different networks.

Various types of security criteria changes (or updates) are possible in a file security system operating to secure files (e.g., documents). The security criteria changes can affect system policies, access rules, various keys, groups or users. In one embodiment, security criteria can pertain to security policies. Some examples of security criteria changes include: (i) changes to group membership; (ii) addition, removal or modification to document access rules; (iii) changes to user keys; and (iv) addition, removal or modification to group access rights. In any case, once a security criteria change occurs, the policy change must be carried out by the security system in a reliable fashion without affecting others that are not subject to the change. Hence, unless to be applied to all users or user computers in the system, the security criteria change is targeted to applicable users. In other words, the security criteria change may be applied to only one user or a group of users (or their clients or user computers). The processing detailed below explains how security criteria changes are effectuated.

The invention is related to processes, systems, architectures and software products for providing pervasive security to digital assets. The invention is particularly suitable in an enterprise environment. In general, pervasive security means that digital assets are secured (i.e., secured items) and can only be accessed by authenticated users with appropriate access rights or privileges. Digital assets may include, but not be limited to, various types of documents, multimedia files, data, executable code, images and texts.

In general, a secured file can only be accessed by authenticated users with appropriate access rights or privileges. Each secured file is provided with a header portion and a data portion, where the header portion contains, or points to, security information (e.g., security criteria). The security information is used to determine whether access to associated data portions of secured files is permitted.

Secured files are files that require one or more keys, passwords, access privileges, etc. to gain access to their content. The security is often provided through encryption and access rules. The files, for example, can pertain to documents, multimedia files, data, executable code, images and text.

In the following description, numerous specific details are set forth in order to provide a thorough understanding of the invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

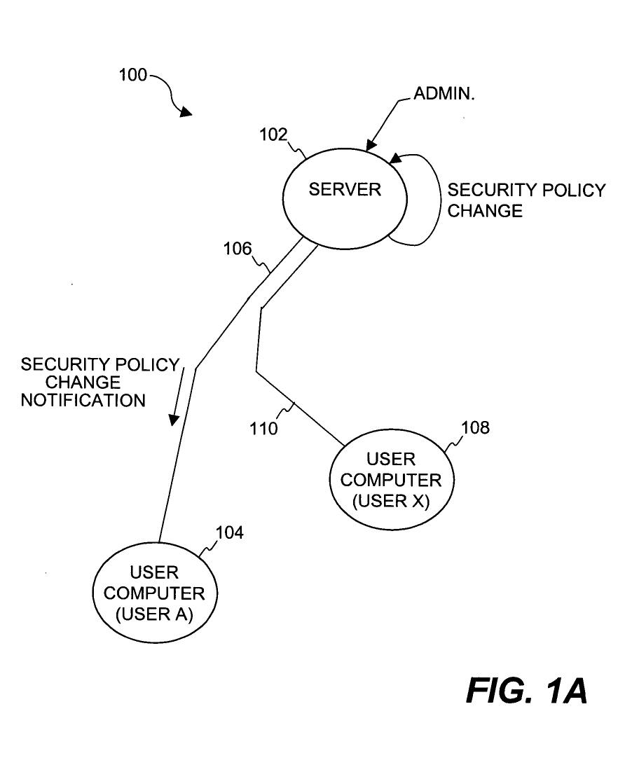

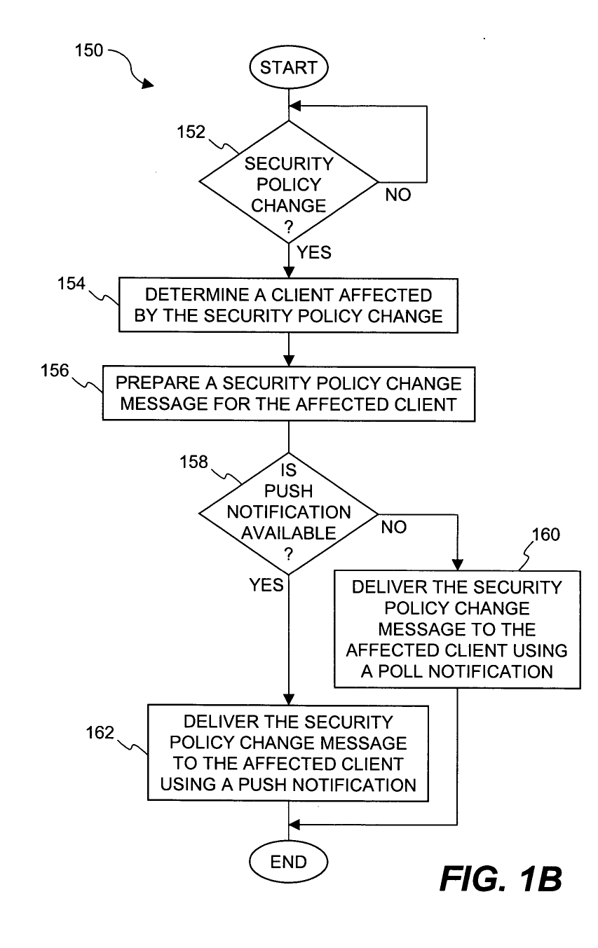

Embodiments of the present invention are discussed herein with reference to FIGS. 1A-8C. However, those skilled in the art will readily appreciate that the detailed description given herein with respect to these figures is for explanatory purposes as the invention extends beyond these limited embodiments.

FIG. 1A is a diagram of a security system 100 according to one embodiment of the invention. The security system 100 operates to restrict access and/or usage to items (e.g., files, documents, etc.) residing within a computer network. By restricting access and/or usage of items, the items are secured or protected from unauthorized access or usage.

The security system 100 includes a server 102. The server 102 couples to a user computer 104 over a link 106 and couples to a user computer 108 over a link 110. The server 102 is a computer that performs centralized access control management or security processing for the security system 100. The user computers 104 and 108 perform localized security processing. The links 106 and 110 can be provided by a network infrastructure which may utilize wired and/or wireless components. Although not shown, the security system 100 could also use one or more local servers to reduce the processing load on the server 102. See, e.g., U.S. application Ser. No. 10/186,203 for additional details.

In general, the security system 100 provides security to items in accordance with security policies. The security policies govern the nature and extent to which security is provided for the items. One representative operation of a security system 100 pertains to implementing changes to security policies and can operate as follows. An administrator interacts with the server 102 to implement a change to the security policies being maintained by the security system 100. In this regard, the administrator would request that a security policy change be implemented for the security system 100. After the security policy change has been requested by the administrator, the server 102 can then send a security policy change notification (e.g., message) to those of the user computers 104, 108 within the security system 100 that are affected by the security policy change. As illustrated in FIG. 1A, the server 102 sends a security policy change notification to the user computer 108 over the link 110. Here, it is assumed that User A, who is using the user computer 108, is affected by the security policy change. Hence, the server 102 informs the user computer 108 of the security policy change by sending the security policy change message to the user computer 104. It should be noted that in this example the server 102 does not provide a security policy change notification to the user computer 108 because its user, User X, is not affected by the security policy change.

The security system according to the invention can, in general, include or make use of one to many user computers and at least one server. The security system can also include or make use of one or more local servers as desired. In other words, the security system can operate in a distributed fashion. Each server (e.g., central server or local server) is able to support one or more users and/or computers. According to the invention, security criteria (e.g., security policy) changes are able to be automatically configured for efficient delivery in such distributed systems.

FIG. 1B is a flow diagram of a security policy change notification process 150 according to one embodiment of the invention. The security policy change notification process 150 can, for example, be performed by a file security server of a file security system.

The security policy change notification process 150 initially begins with a decision 152 that determines whether a security policy change has occurred. The task of the security policy change notification process 150 is to notify one or more clients of the file security system of the security policy change. When the decision 152 determines that a security policy change has not yet occurred, the security policy change notification process 150 awaits such a change. In other words, the security policy change notification process 150 can be deemed invoked when a security policy change has occurred.

On the other hand, once the decision 152 determines that a security policy change has been made, then a client of the file security system that is affected by the security policy change is determined 154. The client is normally a software module operating on a client machine (user computer). Next, a security policy change message is prepared 156 for the affected client. A decision 158 then determines whether a push notification is available. Notifications can either classified as either push-type or pull-type notifications. A push-type notification is directed by the file security server to the client, whereas a pull notification is directed by the client to the file security server. In either case, the file security server provides the information concerning the security policy change to the client.

When the decision 158 determines that push notifications are not available, then the security policy change message is delivered 160 to the affected client using a pull notification. On the other hand, when the decision 158 determines that push notifications are available, then the security policy change message is delivered 162 to the affected user using a push notification. Following the blocks 160 and 162, the security policy change notification process 150 ends.

The security policy change notification process 150 enables the file security system to automatically configure itself for distribution of security policy change notifications. The distribution of such changes to security policies can be deferred for those affected clients that are not activated (e.g., logged-in or on-line) with the file security system. Although discussed in the context of a single client, it should be understood that the file security system normally supports a plurality of clients. In the embodiment shown in FIG. 1A, the determination of whether to use push notifications or pull notifications is done on a client-by-client basis. In general, this determination can be automatically performed (i.e., without having to obtain user input). Additional detail is provided below on how and when availability of push notifications is made. Although poll notifications are normally supported by network topology between the file security server and the client, polling for notification is not efficient in terms of network bandwidth usage. Hence, when permissible, push notifications are preferred. However, some network topologies do not support the two-way network connections needed to support push notifications.

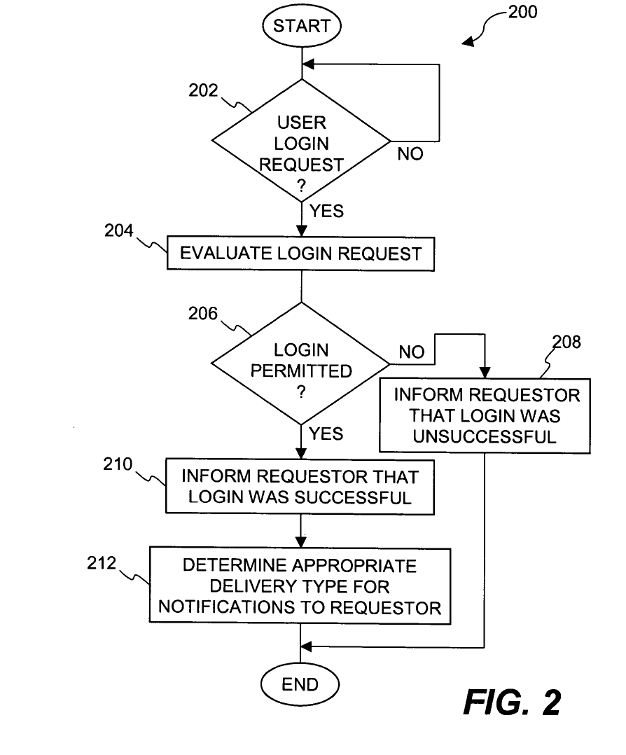

FIG. 2 is a flow diagram of a login process 200 according to one embodiment of the invention. The login process 200 is performed by a file security server associated with a file security system.

The login process 200 begins with a decision 202 that determines whether a user login request has been received from a requestor (i.e., client). When the decision 202 determines that a user login request has not yet been received, then the login process 200 awaits such a request. Once the decision 202 determines that a user login request has been received, the login request is evaluated 204. A decision 206 then determines whether the login is permitted. When the decision 206 determines that the login is not permitted, then the requestor is informed 208 that login was unsuccessful. On the other hand, when the decision 206 determines that login is permitted, the requestor is informed 210 that login was successful. In addition, an appropriate delivery type for notifications to the requestor is then determined 212. Following the blocks 208 and 212, the login process 200 ends.

According to the login process 200, each time a login occurs to the file security system, the appropriate delivery type for notifications to the requestor can be re-evaluated and selected in an automated fashion. This approach is particularly useful for a multi-network or mobile environment where clients connect to the file security system through different networks transparent to users of the clients.

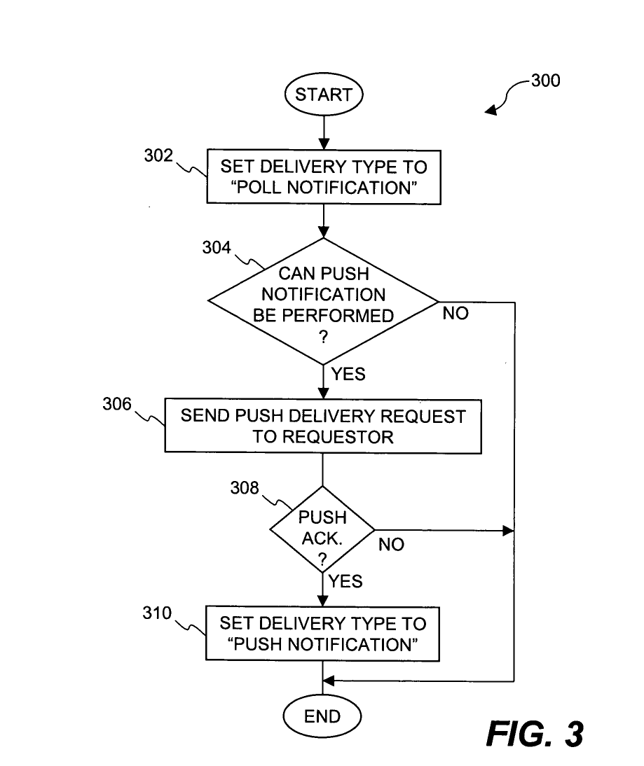

FIG. 3 is a flow diagram of a delivery type determination process 300 according to one embodiment of the invention. The delivery type determination process 300 represents processing that can be performed by the block 212 illustrated in FIG. 2, according to one embodiment of the invention.

The delivery type determination process 300 initially sets 302 a delivery type to “poll notification.” The poll notification is generally always available but less desirable than push notification. A poll notification can also be referred to as a “pull notification.” Accordingly, the poll notification can be used as a default delivery type. After the delivery type has been set 302 to “poll notification,” a decision 304 can determine whether push notifications can be performed. When the decision 304 determines that push notifications cannot be performed, then the delivery type determination process 300 ends with the delivery type being set to “poll notification.”

On the other hand, when the decision 304 determines that push notifications can be performed, a push delivery request is sent 306 to the requestor. Here, the security server of the file security system requests that the requestor (i.e., client) switch to a “push notification” delivery type. In a push delivery type setting, the requestor does not need to burden itself with polling the security server for any security policy changes that may have arisen. Instead, the security server simply “pushes” a notification to the client as security policy changes occur.

After the push delivery request has been sent 306, a decision 308 determines whether a push acknowledgement has been received back from the requester. When the decision 308 determines that the requester has failed to acknowledge the push delivery request, then the delivery type determination process 300 ends, with the delivery type remaining set at “poll notification.”

Alternatively, when the decision 308 determines that the requester has acknowledged the push delivery request, then the delivery type is set 310 to “push notification.” In this manner, in the client-server environment between the security server and the requestor (i.e., client), the switching of delivery types is performed in a deterministic manner such that the file security system can be confident that the requester and the security server both understand the appropriate delivery type to be utilized. Following the block 310, the delivery type determination process 300 ends with the delivery type set at “push notification.”

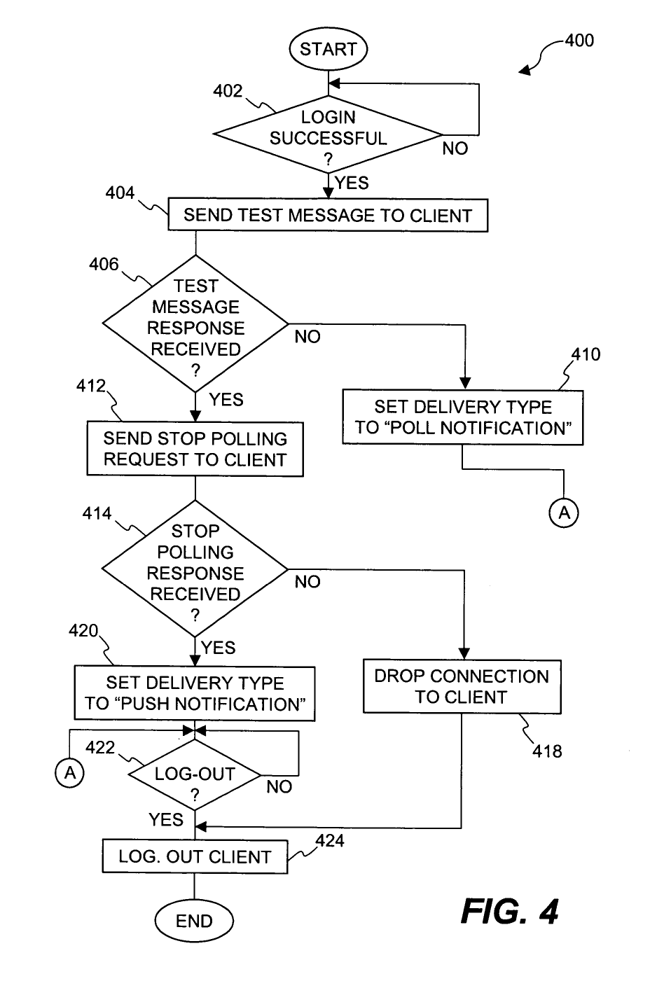

FIG. 4 is a flow diagram of server-side delivery type determination process 400 according to one embodiment of the invention. The server-side delivery type determination process 400 is, for example, performed by a file security server of a file security system.

The server-side delivery type determination process 400 begins with a decision 402 that determines whether a successful login has been achieved. When the decision 402 determines that a successful login has not occurred, then the server-side delivery type determination process 400 awaits a successful login. On the other hand, when the decision 402 determines that a successful login has occurred, a test message is sent 404 to a client (requester). The client (requester) represents a software module operating on a user computer (client machine). Additional details on the evaluation of login requests can be found in U.S. application Ser. No. 10/074,194, which was previously hereby incorporated herein by reference.

Next, a decision 406 determines whether a test message response has been received from the client. When the decision 406 determines that a test message response has not been received, then the delivery type to be utilized with the client is set 410 to “poll notification.”

On the other hand, when the decision 406 determines that a test message response has been received, then a stop polling request is sent 412 to the client. Here, the success of the test message indicates that push notifications might be used between the file security server and the client. Hence, the stop polling request is a request from the file security server to the client to stop using poll notifications and switch to the more efficient push notifications.

Next, a decision 414 determines whether a stop polling response has been received from the client. Here, in response to the stop polling request, the client should return to the file security server a stop polling response, assuming the client received a stop polling request and understood it. When the decision 414 determines that a stop polling response has not been received, then the connection to the client is dropped 418.

On the other hand, when the decision 414 determines that a stop polling response has been received from the client, then the delivery type to be utilized with the client is set 420 to “push notification.” In this case, the client and the file security server both understand that notifications will be communicated using the push delivery type. The file security server is ensured that the client is going to expect push notifications (and not use poll notifications) before the file security server begins to use the push delivery type.

Next, following blocks 410 or 420, a decision 422 determines whether a log-out has occurred. When the decision 422 determines that a log-out has not occurred, then the server-side delivery type determination process 400 can await a log-out. On the other hand, when the decision 422 determines that a log-out has occurred, then the client is logged out 424 from the file security system. Additionally, following block 418, the client is also logged out 424 from the file security system. Following block 424, the server-side delivery type determination process 400 ends.

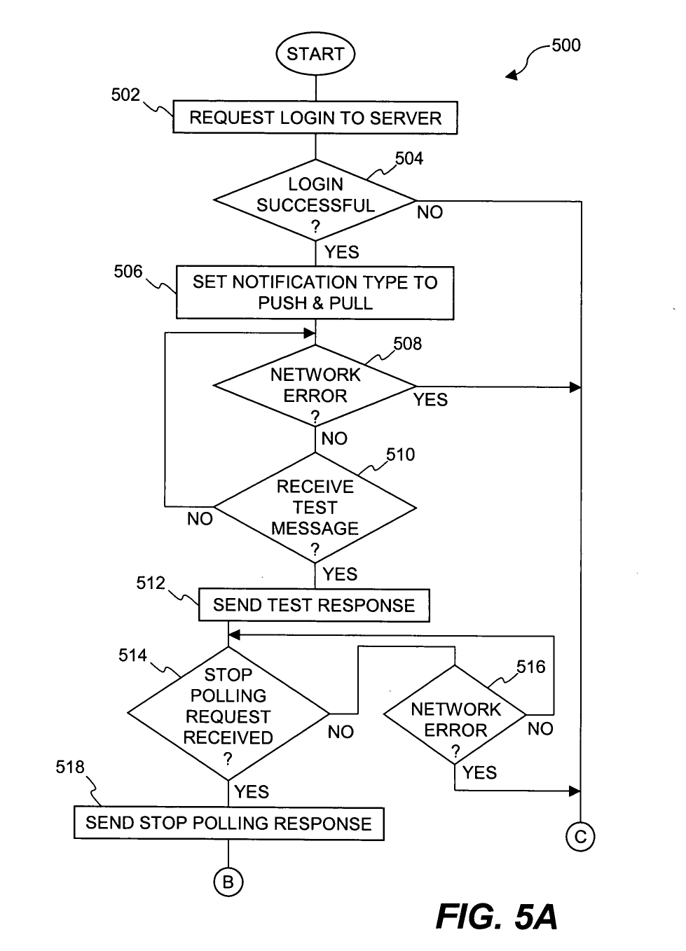

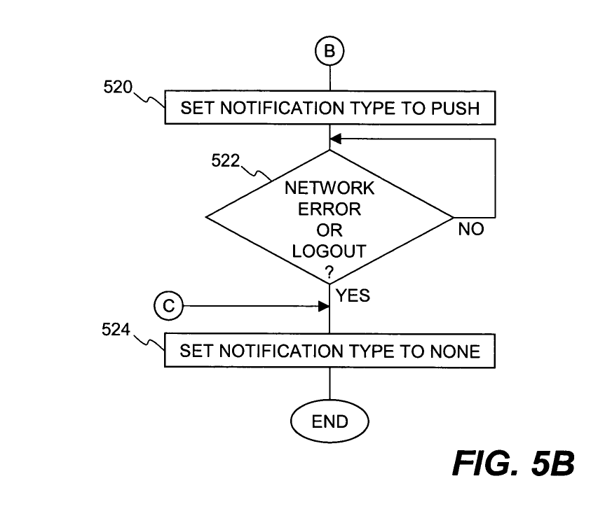

FIGS. 5A and 5B are flow diagrams of a client-side delivery type determination process 500 according to one embodiment of the invention. The client-side delivery type determination process 500 is performed by a client of a file security system. The client is, for example, a software module operating on a client machine.

The client-side delivery type determination process 500 begins with a request 502 to login to a server (file security server). A decision 504 then determines whether the login to the server has been successful. Here, the server will respond back to the client with an indication of whether or not the login was successful.

When the decision 504 determines that the login was successful, then a notification type is set 506 to “Push & Poll”. Push & Poll means that the client will not only periodically poll the server for notifications but also receive notifications being pushed by the server.

Next, a decision 508 determines whether a network error has occurred. When the decision 508 determines that a network error has not occurred, then a decision 510 determines whether a test message has been received. When the decision 510 determines that a test message has not been received, then the client-side delivery type determination process 500 returns to repeat the decision 508 and subsequent operations. In one embodiment, one type of network error is failure to receive a test message within a predetermined period of time. Alternatively, when the decision 510 determines that a test message has been received, then a test response is sent 512 to the server. The test response provides an acknowledgement to the server that the test message was received and understood.

After the test response has been sent 512, a decision 514 determines whether a stop polling request has been received. When the decision 514 determines that a stop polling request has not yet been received, then a decision 516 determines whether a network error has occurred. When the decision 516 determines that a network error has not occurred, then the client-side delivery type determination process 500 returns to repeat the decision 514 and subsequent operations. On the other hand, when the decision 514 determines that a stop polling request has been received, a stop polling response is sent 518 to the server. Here, the stop polling response is an indication by the client that the stop polling request was received and processed, meaning that the client will cease polling the server for security policy changes. In this regard, the notification type is set 520 to “Push”.

Next a decision 522 determines whether a network error or a log-out has occurred. When neither a network error nor a log-out has occurred, the client-side delivery type determination process 500 awaits such events. Once a network error or a log-out has occurred, the notification type is set 524 to “None,” meaning that no notifications are to be thereafter delivered to the client. Following the operation 524, the client-side delivery type determination process 500 is complete and ends.

Additionally, it should be noted that the client-side delivery type determination process 500 also performs the setting 524 of the notification type to “None” whenever login fails, log-out occurs, or network errors occur. As such, the notification type is set 524 to “None” and then the client-side delivery type determination process 500 ends following: the decision 504 when login is unsuccessful, following the decision 508 when a network error occurs, and following the decision 516 when a network error occurs.

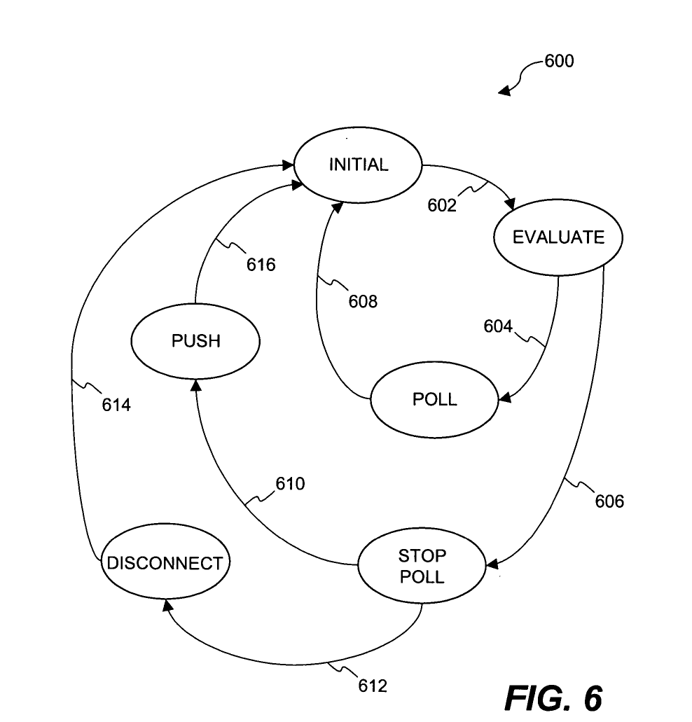

FIG. 6 is a diagram of a server state machine 600 according to one embodiment of the invention. The server state machine 600 is associated with various states of a file security server in the context of notifications of security policy changes. The server state machine 600 includes the states of: INITIAL, EVALUATE, POLL, STOP POLL, PUSH, and DISCONNECT.

The server state machine 600 begins in the INITIAL state. The state machine 600 then transitions 602 from the INITIAL state to the EVALUATE state when a successful login occurs. Then, at the EVALUATE state, there is a determination of whether push notifications can be performed. In other words, whether the network topology of the network connecting the file security server to a client supports two-way communications (and thus push notifications). In one embodiment, during the evaluate process, the file security server sends a test message to a corresponding client to see whether the client is able to receive the message. When the security server does not receive a response, the server state machine 600 transitions 604 to the POLL state. On the other hand, when the file security server does receive a response from the client, the server state machine 600 transitions 606 to the STOP POLL state. At the POLL state, the file security server waits for a POLL request from the client and then responds to it. In the event that the client is logged out from the file security server, the server state machine 600 transitions 608 from the POLL state back to the INITIAL state. Alternatively, when at the STOP POLL state, the file security server sends a stop polling request to the client. When the client responds that it received the stop polling request, then the server state machine 600 transitions 610 from the STOP POLL state to the PUSH state. Alternatively, when the client does not respond to the STOP POLL request, the server state machine 600 transitions 612 from the STOP POLL state to the DISCONNECT state. Further, following the DISCONNECT state, the server state machine 600 transitions 614 to the INITIAL state. Also, when a logout occurs while in the PUSH state, the server state machine 600 transitions 616 from the PUSH state to the INITIAL state.

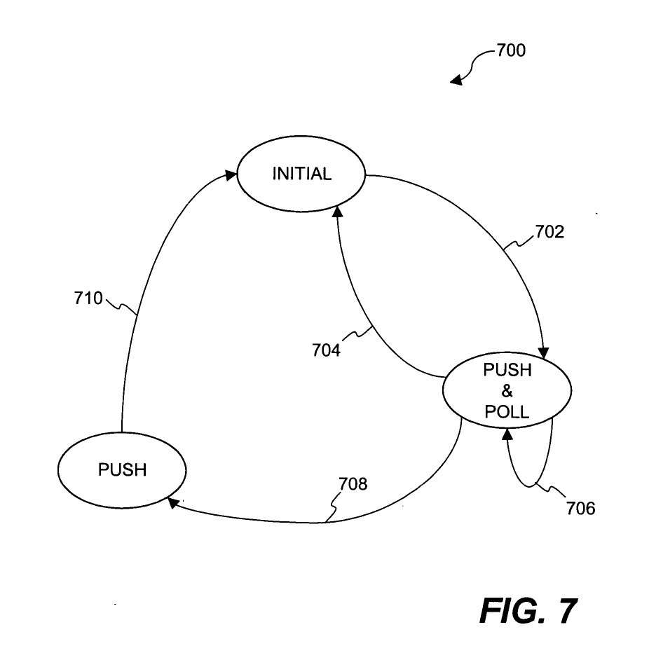

FIG. 7 is a diagram of a client state machine 700 according to one embodiment of the invention. The client state machine 700 is associated with various states of a client machine in the context of notifications of security policy changes. The client state machine 700 can cooperate with the server state machine 600 illustrated in FIG. 6. The client state machine 700 includes the states of: INITIAL, PUSH & POLL, and PUSH. The client state machine 700 initializes itself into the INITIAL state. Upon successful login, the client state machine 700 transitions 702 from the INITIAL state to the PUSH & POLL state. While in the PUSH & POLL state, if the client is logged out or a network error occurs, the client state machine 700 transitions 704 from the PUSH & POLL state to the INITIAL state. For example, to determine whether a network error has occurred, the client can periodically check (e.g., “ping”) the network connection and if an error is detected in the network connection, then the transition 704 can be made. While in the PUSH & POLL state, if the client state machine 700 receives a request pertaining to push notification capability (e.g., test message of the server state machine 600), the client state machine 700 can send 706 a response back to the file security server. Also, when in the PUSH & POLL state, and a stop poll notification is received from the file security server, the client state machine 700 can transition 708 from the PUSH & POLL state to the PUSH state. Thereafter, if a client is logged out or if a network error occurs, the client state machine 700 transitions 710 from the PUSH state to the INITITAL state.

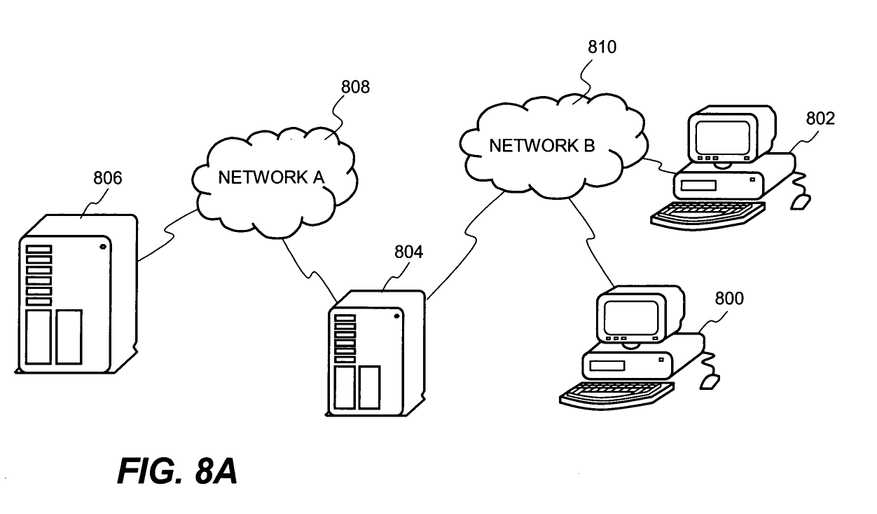

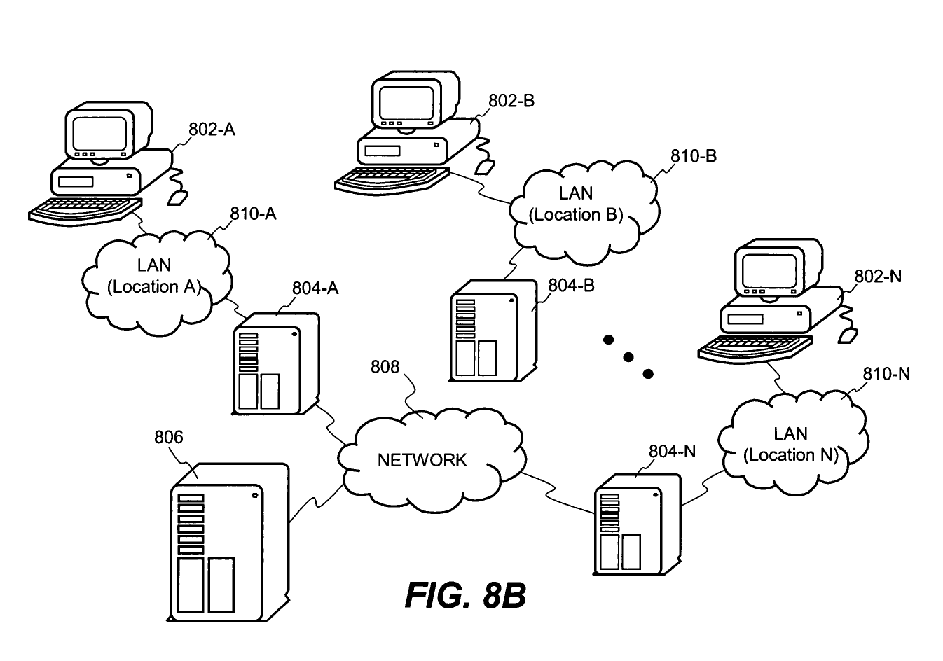

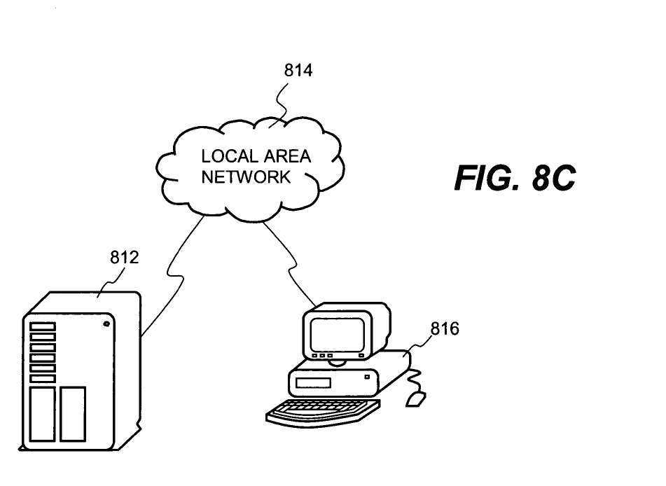

FIG. 8A shows a basic system configuration in which the present invention may be practiced in accordance with one embodiment thereof. Documents or files may be created using an authoring tool executed on a client computer 800, which may be a desktop computing device, a laptop computer, or a mobile computing device. Exemplary authoring tools may include application programs such as Microsoft Office (e.g., Microsoft Word, Microsoft PowerPoint, and Microsoft Excel), Adobe FrameMaker and Adobe Photoshop.

According to one embodiment, the client computer 800 is loaded with a client module that is capable of communicating with a server 804 or 806 over a data network (e.g., the Internet or a local area network). According to another embodiment, the client computer 800 is coupled to the server 804 through a private link. As will be further explained below, a document or file created by an authoring tool can be secured by the client module. The client module, when executed, is configured to ensure that a secured document is secured at all times in a store (e.g., a hard disk or other data repository). The secured documents can only be accessed by users with proper access privileges. In general, an access privilege or access privileges for a user may include, but not be limited to, a viewing permit, a copying permit, a printing permit, an editing permit, a transferring permit, an uploading/downloading permit, and a location permit.

According to one embodiment, a created document is caused to go through an encryption process that is preferably transparent to a user. In other words, the created document is encrypted or decrypted under the authoring application so that the user is not aware of the process. One or more keys, such as a user key and a content type key, can be used to retrieve a file key to decrypt an encrypted document. Typically, the user key is associated with an access privilege for the user or a group of users, and the content type key is associated with the type of content of the created document. For a given secured document, only a user with proper access privileges can access the secured document.

In one setting, a secured document may be uploaded via the network 810 from the computer 800 to a computing or storage device 802 that may serve as a central repository. Although not necessary, the network 810 can provide a private link between the computer 800 and the computing or storage device 802. Such link may be provided by an internal network in an enterprise or a secured communication protocol (e.g., VPN and HTTPS) over a public network (e.g., the Internet). Alternatively, such link may simply be provided by a TCP/IP link. As such, secured documents on the computer 800 may be remotely accessed.

In another setting, the computer 800 and the computing or storage device 802 are inseparable, in which case the computing or storage device 802 may be a local store to retain secured documents or receive secured network resources (e.g., dynamic Web contents, results of a database query, or a live multimedia feed). Regardless of where the secured documents or secured resources are actually located, a user, with proper access privileges, can access the secured documents or resources from the computer 800 or the computing or storage device 802 using an application (e.g., Internet Explorer, Microsoft Word or Acrobat Reader).

The server 804, also referred to as a local server, is a computing device coupled between a network 808 and the network 810. According to one embodiment, the server 804 executes a local version of a server module. The local version is a localized server module configured to service a group of designated users or client computers, or a location. Another server 806, also referred to as a central server, is a computing device coupled to the network 808. The server 806 executes the server module and provides centralized access control management for an entire organization or business. Accordingly, respective local modules in local servers, in coordination with the central server, form a distributed mechanism to provide distributed access control management. Such distributed access control management ensures the dependability, reliability and scalability of centralized access control management undertaken by the central server for an entire enterprise or a business location.

FIG. 8B shows another system configuration in which the invention may be practiced in accordance with an embodiment thereof. Here, the configuration employs a central server and local servers. The configuration may correspond to a large enterprise having multiple geographic locations or offices. A central server 806 maintains a database managing the access privileges and the access rules in the entire enterprise. One of the features in this configuration is the underlying capability to provide fault tolerance and efficient AC (Access Control) management for a large group of users. Instead of having the central server 806 performing the AC management for each of the users at one single location, a number of local servers 804 (e.g., 804-A, 804-B, . . . 804-N) are employed in a distributed manner to service the individual locations or offices. Each of local servers 804 executes a local module derived or duplicated from the server module being executed at the central server 806 to manage those users who are local to respective local servers 804. The central server 806 can centralize the AC management in addition to managing the users if necessary.

According to one embodiment, a local module can be a customized version of the server module that runs efficiently for only a few locations or a group of users. For example, a local server 804-A is only responsible for the users or computers 802-A in location A, while a local server 804-B is only responsible for the users or computers 802-B in location B. As a result, even if the central server 806 has to be taken down for maintenance or is not operational at the time a user needs to access secured documents, the access control will not be disrupted. The detailed operation of the local servers 804 in cooperation with the central server 806 will be further described below.

According to another embodiment, a local module is a replicated version of the server module and exchanges any updates with the server module when connected (e.g., periodically or at request). Depending on implementation, part or all of the server module can be duplicated in a local server to ensure that communications with users or their client machines are efficient and fault tolerant. As a result, even if the central server 806 has to be taken down for maintenance or is not operational at the time a user needs to access secured documents, the access control will not be disrupted. For example, in such a situation, any of the local servers 804 can step up and take the place of the central server. When the central server 806 is running or communicating with the local servers 804, information collected at the respective local servers about the users or their activities is sent back to the central server 806. The detailed operation of the local servers 804 in cooperation with the central server 806 in this regard will also be further provided below.

FIG. 8C shows still another system configuration in which the invention may be practiced in accordance with an embodiment thereof. This configuration is suitable for a small group of users. In this configuration, no local servers are employed. A server computer 812 is loaded with the server module and each of the users or terminal computers 816 (only one is shown therein) is loaded with a client module. The users or the terminal computers 816 couple to the server computer 812 through a local area network. The server computer 812 performs the AC management for each of the users or the terminal computers 816.

Security policies including system policies and access rules protect or secure electronic data. In general, the access rules are provided in a secured item and have been previously described. The system policies are rules that provide restrictions imposed by the system. Examples of the various levels of rules may include one or more system rule sets at a server machine and/or a client machine, a special rule set imposed by a system operator and the rule set associated with or embedded in a secured file. In dealing with highly sensitive files, a system rule can limit a user to accessing certain secured documents from only certain designated computers. In a distributed system in which a number of local servers are used, some of the changes to the system rules may only originate from a central server to one or more of the local servers being affected. Similarly, some of the changes to the system rules may only originate from one or more of the local servers to one or more of the user computers being affected.

The following table illustrates some exemplary commands to carry out a system policy update or change originated from a server to a user computer or client machine (CM):

| | |
|---|---|
| int | notifyAddedDocRule(int policyId, int docRuleId, |
| | byte[] docRuleText) |
| | notifies the CM that a doc rule has been added to a policy |
| int | notifyAddedGroupGenSysRight(String userId, String groupId, |
| | int rightKey) |
| | notifies a CM that a general system right has been added to the group |
| int | notifyAddedGroupSpecSysRight(String userId, String groupId, |
| | int rightKey, String pertinentGroupId) |
| | notifies a CM that a specific system right has been added to the group |
| int | notifyAddedPolicy(int policyId, String policyName) |
| | notifies a CM that a new policy has been created |
| int | notifyAddedUserGenSysRight(String userId, int rightKey) |
| | notifies a CM that a general system right has been added to the user |
| int | notifyAddedUserSpecSysRight(String userId, int rightKey, |
| | String pertinentGroupId) |
| | notifies a CM that a specific system right has been added to the user |
| int | notifyAddedUserToGroup(String userId, String newGroupId, |
| | HashMap newGroupInfo) |
| | notifies a CM that the user now belongs to a new group |
| int | notifyChangedActiveFolderTree(String userId, String newTree) |
| | notifies a CM that the active folder tree has been changed |
| int | notifyChangedDocRuleText(int policyId, int docRuleId, |
| | byte[] newDocRuleText) |
| | notifies a CM that a document rule has been modified |
| int | notifyChangedGroupKeyPair(String userId, String groupId, |
| | byte[] groupPubKey, byte[] groupPrivKey) |
| | notifies a CM that a group key pair has been changed |
| int | notifyChangedSystemRules(String userId, String newRules) |
| | notifies a CM that the system rules have been changed |
| int | notifyChangedUserDefaultGroup(String userId, |
| | String newDefaultGroup) |
| | notifies a CM that the user's default group has changed |
| int | notifyDroppedDocRule(int policyId, int docRuleId) |
| | notifies a CM that a document rule has been dropped from a policy |
| int | notifyDroppedGroupGenSysRight(String userId, String groupId, |
| | int rightKey) |
| | notifies a CM that a general system right has been |
| | dropped from the group |
| int | notifyDroppedGroupSpecSysRight(String userId, String groupId, |
| | int rightKey, String pertinentGroupId) |
| | notifies a CM that a specific system right has |
| | been dropped from the group |
| int | notifyDroppedPolicy(int policyId) |
| | notifies a CM that a new policy has been dropped |
| int | notifyDroppedUserFromGroup(String userId, String groupId) |
| | notifies a CM that the user has been dropped from a group |
| int | notifyDroppedUserGenSysRight(String userId, int rightKey) |
| | notifies a CM that a general system right has |
| | been dropped from the user |
| int | notifyDroppedUserSpecSysRight(String userId, int rightKey, |
| | String pertinentGroupId) |
| | notifies a CM that a specific system right |
| | has been dropped from the user |
| int | notifyUserForcedLogout(String userId, int flag) |
| | notifies that the user needs to be logged out, for various reasons. |

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The various embodiments, implementations and features of the invention noted above can be combined in various ways or used separately. Those skilled in the art will understand from the description that the invention can be equally applied to or used in other various different settings with respect to various combinations, embodiments, implementations or features provided in the description herein.

The advantages of the invention are numerous. Different embodiments or implementations may yield one or more of the following advantages. One advantage of the invention is that policy changes are distributed dependent on network topology. Another advantage of the invention is that policy changes are implemented efficiently, transparently and without user interaction.

The foregoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

1. A computer-implemented method for providing a security change notification to clients of a file security system, said method comprising:
interacting with a first client of the file security system to determine a determined delivery type for security criteria change notifications;
determining whether a security criteria change to the file security system has been made;
preparing a security criteria change notification based on the security policy change; and
delivering the security criteria change notification to the first client using the determined delivery type.

2. A computer-implemented method as recited in claim 1, wherein the clients are client-side programs of the file security system, the client-side programs being operable on client machines.

3. A computer-implemented method as recited in claim 1, wherein said interacting is separately performed for each of the clients, thereby providing a determined delivery type for each of the clients.

4. A computer-implemented method as recited in claim 3, wherein said method further comprises:
determining which of the clients are affected by the security criteria change, and
wherein said delivering operates to deliver the security criteria change notification to each of the determined clients using the delivery type corresponding to each of the clients.

5. A method as recited in claim 4, whereby only the determined clients receive the security criteria change notification.

6. A computer-implemented method as recited in claim 1, wherein said interacting uses at least one handshake operation between the file security system and the first client for deterministic changes in the delivery type for use with the first client.

7. A computer-implemented method as recited in claim 1, wherein said interacting is performed for each of the clients following successful login to the file security system by users associated with each of the clients.

8. A computer-implemented method as recited in claim 1, wherein the determined delivery type is one of a poll delivery type and a push delivery type.

9. A computer-implemented method as recited in claim 1, wherein said interacting comprises:
determining whether a first delivery type can be used for security criteria change notifications to be delivered to the first client;
requesting that the first client use the first delivery type for security criteria change notifications when said determining determines that the first delivery type can be used;
determining whether an acknowledgement of said requesting has been received; and
setting the first delivery type to be used for security criteria change notifications when said determining determines that the acknowledgement of said requesting has been received.

10. A computer-implemented method as recited in claim 1, wherein the determined delivery type is one of a first delivery type and a second delivery type, and
wherein said interacting comprises:
sending a test message to the first client;
determining whether a response to the test message has been received from the first client; and
utilizing the second delivery type for security criteria change notifications when said determining determines that no response from the first client was received.

11. A computer-implemented method as recited in claim 10, wherein said interacting further comprises:
requesting that the first client use the first delivery type for security criteria change notifications when said determining determines that the response from the first client was received;
determining whether an acknowledgement of said requesting has been received; and
utilizing the first delivery type for policy change notifications when said determining determines that the acknowledgement of said requesting has been received.

12. A computer-implemented method as recited in claim 11, wherein said method is performed without user input.

13. A computer-implemented method as recited in claim 11, wherein said security system has a security server that communicates with the clients over a network, and
wherein said method is performed by the security server.

14. A computer-implemented method as recited in claim 13, wherein the computer network is an enterprise computer network.

15. A computer-implemented method as recited in claim 1, wherein the security criteria change alters at least one of an access rule or a group's membership.

16. A computer-implemented method as recited in claim 1, wherein the security criteria change, when effectuated, affects restrictive access to files secured by the file security system.

17. A computer-implemented method for providing a security change notification to a client of a file security system, the client communicates with the file security system via a network, said method comprising:
placing the client into a first state that causes the client to poll the file security system to inquire whether there are any security criteria change notifications for the client and to obtain security criteria changes for the client if there are any;
automatically assisting the file security system with an evaluation of network topology of the network;
subsequently receiving a request to switch the client to a second state in which the client is not required to poll the file security system in order to obtain any security criteria change notifications for the client, the request being sent to the client from the file security system dependent on the network topology; and
switching the client from the first state to the second state in response to the request.

18. A computer-implemented method as recited in claim 17, wherein said method further comprises:
initiating, prior to said placing the client into the first state, the client into an initial state in which the client does not receiving any information concerning security criteria change notifications.

19. A computer-implemented method as recited in claim 18, wherein said placing comprises:
assisting a user to login into the file security system; and
transitioning from the initial state to the first state following successful login of the user.

20. A computer-implemented method as recited in claim 17, wherein the security criteria change, when effectuated, affects restrictive access to files secured by the file security system.

21. A security system for securing files from unauthorized access within a distributed computer network, said security system comprising:
a server module operating on a server; and
a plurality of client modules operating on respective user computers,
wherein said server module stores security policy information that governs a type and extent of access to secured files that are permitted by users via the respective user computers,
wherein said client modules receive some or all of the portion of the security policy information from said server module, and
wherein said server module and said client module interact, without user input, to determine a manner by which said client modules are to be notified of subsequent changes to the security policy information.

22. A security system as recited in claim 21, wherein when a security policy change is received at said server module, said server module identifies those of said client modules that are affected by the security policy change, and thereafter informs said client modules that are affected of the security policy change.

23. A security system as recited in claim 22, wherein said client modules that are affected thereafter update the security information at said client modules that are affected.

24. A computer readable medium including at least computer program code for providing a security change notification to clients of a file security system, said computer readable medium comprising:
computer program code for interacting with a first client of the file security system to determine a determined delivery type for security criteria change notifications;
computer program code for determining whether a security criteria change to the file security system has been made;
computer program code for preparing a security criteria change notification based on the security policy change; and
computer program code for delivering the security criteria change notification to the first client using the determined delivery type.

25. A computer readable medium including at least computer program code for providing a security change notification to a client of a file security system, the client communicates with the file security system via a network, said computer readable medium comprising:
computer program code for placing the client into a first state that causes the client to poll the file security system to inquire whether there are any security criteria change notifications for the client, and to obtain security criteria changes for the client if there are any;
computer program code for automatically assisting the file security system with an evaluation of network topology of the network;
computer program code for subsequently receiving a request to switch the client to a second state in which the client is not required to poll the file security system in order to obtain any security criteria change notifications for the client, the request being sent to the client from the file security system dependent on the network topology; and
computer program code for switching the client from the first state to the second state in response to the request.
